(19) United States
(12) Patent Application Publication
(10) Pub. No.: US 2026/0224065 A1
(43) Pub. Date: Aug. 6, 2026

(54) MACHINE FOR DISPENSING INFUSION BEVERAGES

(71) Applicant: LELIT S.R.L., Castegnato (Brescia) (IT)

(72) Inventor: Mauro EPIS, Castegnato (Brescia) (IT)

(21) Appl. No.: 19/151,072

(22) PCT Filed: Jan. 29, 2024
(86) PCT No.: PCT/IB2024/050798

§ 371 Date: Jul. 25, 2025

(30) Foreign Application Priority Data
Feb. 1, 2023 (IT) 102023000001566

(51) Int. Cl. A47J 31/46; A47J 31/52; A47J 31/56

(52) U.S. Cl. CPC A47J 31/469; A47J 31/461; A47J 31/468; A47J 31/525; A47J 31/56

(57) ABSTRACT

A machine for dispensing an infusion beverage has a boiler, a drawing tube, a heat exchanger and a dispensing unit. The boiler extends between a lower end delimited by a bottom wall, and an upper end delimited by a top wall. The drawing tube extends between a first end and a second end. The boiler is configured to obtain at the lower end a significantly lower infusion fluid temperature than that obtainable at the upper end. The first end of the drawing tube is positioned close to the bottom wall to draw an infusion fluid in a liquid state for a pre-infusion step or a step of feeding a service tap.

The present invention is in the technical sector of machines for dispensing infusion beverages, for example coffee, tea, chamomile tea, herbal tea etc. The object of the present invention is a machine for dispensing an infusion beverage, preferably for domestic use.

As is known, machines for dispensing infusion beverages, which include the heating of the infusion fluid by means of a heat exchanger, produce steam and splashing during the infusion step and/or during the step of dispensing the infusion fluid through a service tap. The infusion fluid is preferably water.

As regards the pre-infusion step, otherwise known as “blooming”—this consists in wetting a substance to be infused at a pressure of between 0 and 4 bar so as to compress such substance. The substance to be infused is preferably ground or powdered coffee and, with pre-infusion, a compacted tablet is obtained which ensures the subsequent uniform dispensing of the beverage.

The dispensing step is actually performed using two different methods.

The first method may only be implemented using machines comprising an E61 type dispensing unit otherwise known as an L58E dispensing unit—and connected to the water supply. It is known to the skilled in the art person that in the E61 dispensing unit described in the documents U.S. Pat. Nos. 3,314,357 and 3,230,974—a cam is connected to an actuating lever that may be arranged in a closed, open or intermediate position. In the closed position, the actuating lever does not allow any passage of the infusion fluid; on the other hand, in the open position, the passage of fluid through the dispensing unit is enabled. When the lever is in the intermediate position, the pressure of the water supply, typically of between 2 and 4 bar, is used to perform the pre-infusion step without activating the pump unit. Preferably, the machine also comprises a microswitch which controls the operation of the pump unit and, when the actuating lever is in the closed position, the microswitch is not actuated. On the other hand, when the lever is in the open position and the microswitch is actuated, the pump unit may function normally.

Disadvantageously, the first method for performing the pre-infusion step may only be implemented with machines that are connected to the water supply. It is evident that a water supply connection implies additional work as regards the installation of the machine, for example it is necessary to involve a plumber in order to modify the water installation, a builder for the masonry work and/or flooring work, carpenter for any modification to furniture and a tiler for finishing walls and/or floors after the installation work has been completed. Other than the machine installation costs it is necessary to consider that once installed, insofar as it is rigidly connected to the water supply, the machine may not be easily moved.

A further disadvantage of the first method lies is the fact that the pump unit, in order to connect the machine to the water supply, has to comprise a rotary pump insofar as a vibratory pump is less suitable for the water connection than a rotary pump.

The second method for performing the pre-infusion step may only be implemented with machines for dispensing infusion beverages comprising at least two boilers. For example, the document IT 201900018581 A1 describes a machine that is equipped with two different boilers that are completely independent therebetween.

Disadvantageously, the presence of two boilers results in a greater structural complexity in the manufacturing of the machine, an increase in production costs and a larger machine size.

A still further disadvantage, which is common both to the first and the second methods, is the emission of steam and/or splashes from the dispensing unit during the pre-infusion step. Apart from the connection to the water supply or the presence of two boilers, the fluid to be used for the pre-infusion is taken by a drawing tube that is positioned at an upper end of the boiler and, due to the positioning of the drawing tube, infusion fluid is taken both in the liquid and the gaseous states. The pre-infusion step is therefore accompanied by the emission of splashes and steam due to both liquid and gaseous infusion fluid being used for wetting the substance to be infused. Such disadvantage also occurs during the beverage infusion and dispensing step, wherein the emission of splashes and steam is associated with the outflow of the infused beverage. Disadvantageously, the steam that is produced, which is typically water vapor, is released into the space adjacent to the machine and condensing it liquefies forming water drops. It is evident how the formation of water drops and humidity might damage any household appliances and furniture that is in the vicinity of the machine.

Beverage splashes that are produced during the pre-infusion or dispensing steps may also damage and soil what is positioned close to the machine. For example, the elevated temperature of the beverage splash during dispensing may locally damage materials that are particularly sensitive to temperature (for example wood) or, if the stain is not removed in a timely manner and left to dry, the splash may leave marks and irreparably compromise the aesthetics of work tops, furniture and household appliances.

As regards the dispensing of the infusion fluid through the service tap, in machines according to the state of the art the infusion fluid is instead taken directly by the boiler by means of the drawing tube positioned at the upper end of the boiler. As is known the boiler is filled from 50%-80% with fluid in the liquid state, for example hot water, and the remaining 50%-20% with fluid in the gaseous state, for example steam. Preferably, around 70% is hot water and the remaining 30% is steam. The hot water is used to dispense the infusion beverage and to supply the service tap, whilst the steam is dispensed through a further tap and used for frothing the milk.

In particular, in machines according to the prior art the boiler is at a boiler temperature of between 120 and 135° C. and at a pressure of around 1 bar. It is evident that, due to the position of the drawing tube and the elevated temperature of the boiler, in feeding the service tap infusion fluid is taken that is both in the liquid and the gaseous state.

Disadvantageously, the contemporaneous drawing of both liquid and gaseous infusion fluid leads to the outflow of steam and splashing from the service tap where only hot water should emerge.

It should be noted that the service tap has a dual function, namely to recirculate the infusion fluid contained in the boiler and to dispense fluid in a liquid state for the separate preparation of infusion beverages. In particular, due to the elevated boiler temperature, the fluid contained therein may lose some qualitative properties, for example mineral salts present in the water may precipitate thereby altering the chemical composition of the same; it is therefore recommended to regularly change the infusion fluid present in the boiler so as to reintroduce it. Furthermore, the fluid in the liquid state that is dispensed by the service tap may also be used to prepare infusion beverages, for example using hot water it is possible to prepare tea, chamomile tea, herbal tea by immersing into the water a bag of the substance to be infused.

Further examples of machines for dispensing infusion beverages are presented in the documents WO 01/24671 A1 and CH 341975 A.

The object of the present invention is to propose a machine, a method and a control unit capable of at least partially overcoming the drawbacks mentioned above. Said object is achieved with a machine for dispensing an infusion beverage according to claim 1, with a method for pre-infusion and/or for feeding a service tap according to claim 13 and with a control unit according to claim 19. The dependent claims describe preferred embodiments of the invention.

The features and the advantages of the machine, of the method and of the control unit according to the invention shall be made readily apparent from the following description of preferred embodiments thereof, provided purely by way of a non-limiting example, with reference to the accompanying figures, wherein:

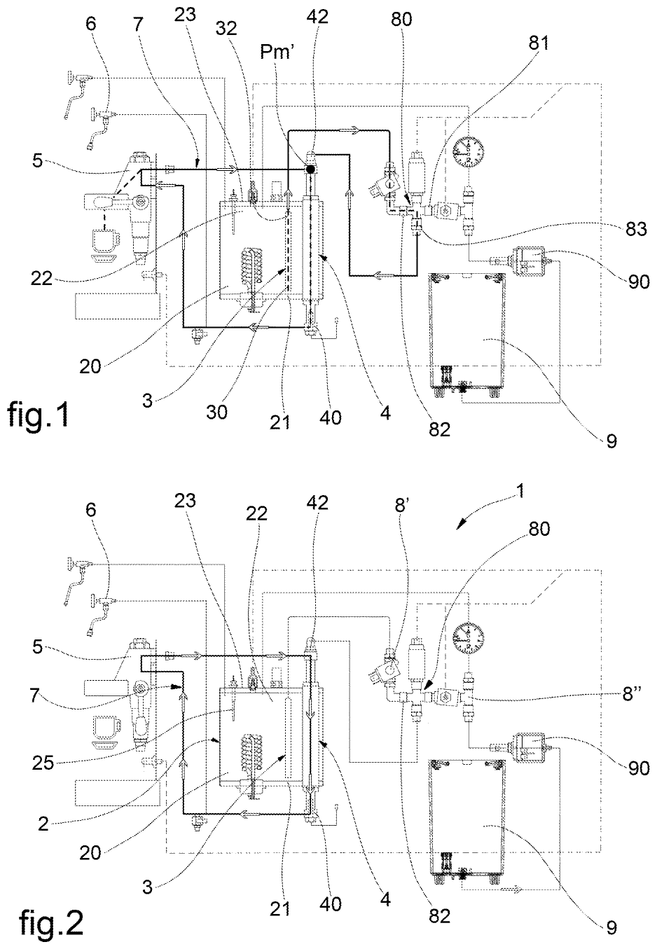

FIG. 1 is a schematic view of a machine for dispensing an infusion beverage during a pre-infusion step;

FIG. 2 is a view of the machine in an inactive configuration;

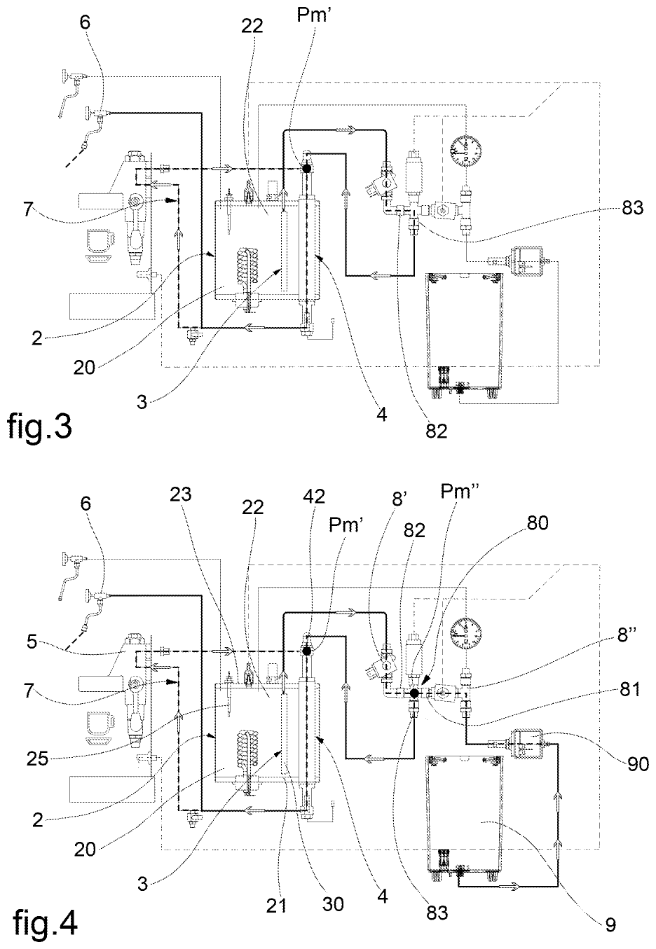

FIG. 3 is a view of the machine during a step of feeding a service tap;

FIG. 4 is a view of the machine during a step of feeding the service tap when the level of an infusion fluid in a boiler falls below a threshold value;

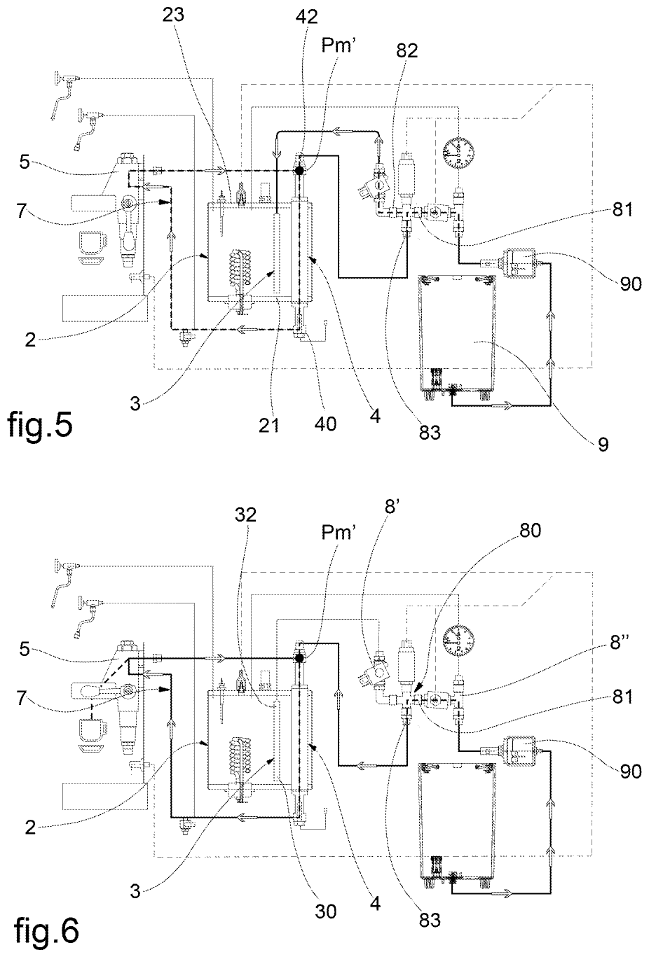

FIG. 5 is a view of the machine during a step of filling the boiler and of a heating circuit;

FIG. 6 is a view of the machine during a step of dispensing the beverage;

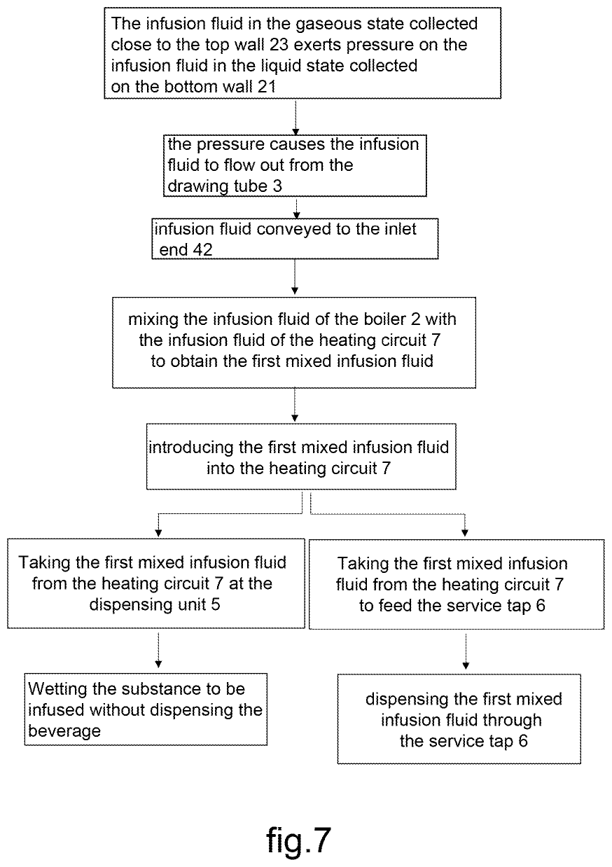

FIG. 7 is a flow diagram relating to a method for pre-infusion and/or for feeding the service tap; and

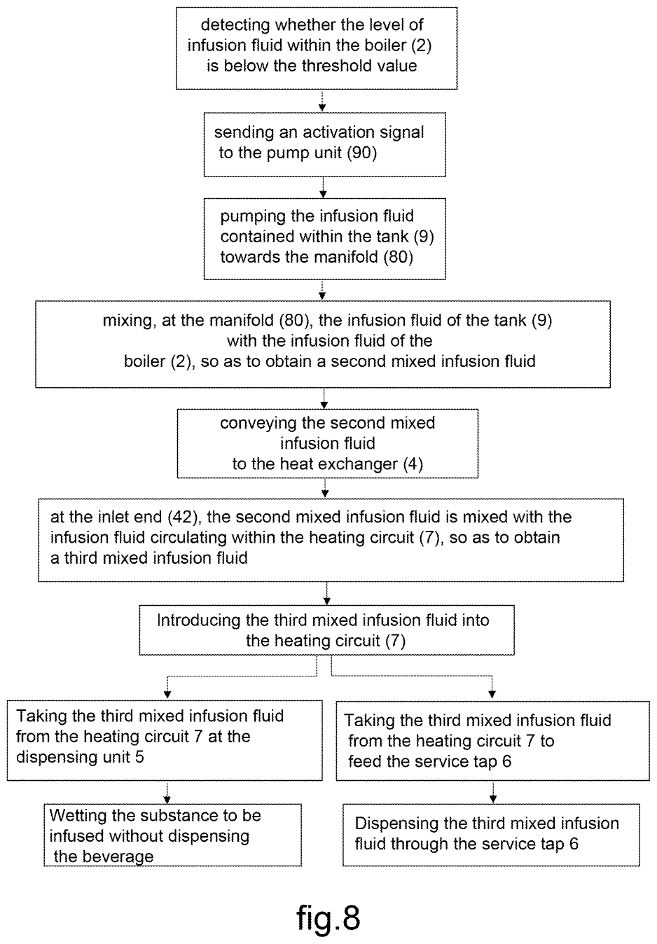

FIG. 8 is a flow diagram relating to the method for pre-infusion and/or for feeding the service tap when the level of infusion fluid in a boiler falls below a threshold value.

For the purpose of correct interpretation of the accompanying figures, it should be noted that the directional arrows indicate the direction of flow of the infusion fluid.

In the following description, elements common to the various embodiments represented in the drawings are indicated with the same reference numerals.

In the accompanying drawings, the machine for dispensing an infusion beverage according to the invention is indicated in the entirety thereof with 1.

According to the present invention, the machine 1 comprises a boiler 2, a drawing tube 3, a heat exchanger 4 and a dispensing unit 5.

Preferably, the infusion beverage is a coffee based beverage.

The boiler 2 is suitable for heating an infusion fluid and extends between a lower end 20, delimited by a bottom part 21, and an upper end 22, delimited by a top wall 23.

For the purposes of the present description the terms “lower” and “top” and the derivatives thereof are intended to refer to the machine 1 in operation, that is, during the operation thereof.

The drawing tube 3 is at least partially accommodated in the boiler 2 and extends between a first end 30 and a second end 32. Preferably, the second end 32 is connected to the top wall 23 without protruding from the boiler 2.

The heat exchanger 4 extends between an inlet end 42, for the inflow of the infusion fluid, and an outlet end 40, for the outflow of the infusion fluid.

Preferably, the heat exchanger 4 is suitable for dispensing the infusion fluid at an exchanger temperature between 85 and 99° C.

The dispensing unit 5, for example of the E61 type, is suitable for dispensing the infused beverage.

The boiler 2 is configured to obtain, at the lower end 20, and in particular on the bottom wall 21, a significantly lower infusion fluid temperature than that obtainable at the upper end 22, in particular on the top wall 23.

In the example, the boiler 2 comprises a heating element that is suitable for heating the infusion fluid. It is known to a person skilled in the art that the gaseous state has a lower density than the liquid state. Liquid therefore collects at the lower end 20, whilst steam collects at the upper end 22.

The bottom wall 21 is preferably suitable for collecting the infusion fluid in the liquid state, whilst the top wall 23 is suitable for collecting the infusion fluid in the gaseous state.

The first end 30 of the drawing tube 3 is positioned close to the bottom wall 21 of the boiler 2 to draw the infusion fluid in the liquid state being usable for the pre-infusion step or to feed a service tap 6.

The infusion fluid is preferably water.

According to a preferred embodiment, the machine 1 for dispensing the infusion beverage comprises one and only one boiler 2.

According to an embodiment shown in the accompanying FIGS. 1 and 2, the machine 1 may be converted between an inactive configuration and an active configuration.

In the inactive configuration (FIG. 2), the heat exchanger 4 is fluidically connected to the dispensing unit 5 so as to define a heating circuit 7 suitable for allowing the continuous recirculation of the infusion fluid between the heat exchanger 4 and the dispensing unit 5. By virtue of the heating circuit 7, the dispensing unit is kept at a temperature of 80-95° C. without dispensing any beverages. The heating circuit 7 preferably comprises the heat exchanger 4, an outward path for the infusion fluid from the outlet end 40 to the dispensing unit 5, and a return path from the dispensing unit 5 to the inlet end 42. Advantageously, the heating circuit avoids cooling of the dispensing unit.

In particular, also in the embodiment shown in FIG. 5 the machine 1 is in the inactive configuration; such circumstance occurs when the level of infusion fluid in the boiler 2 is below a threshold value and infusion fluid is therefore pumped in order to fill the boiler 2 or to fill both the boiler 2 and the heating circuit 7.

In the active configuration (for example FIG. 1), the boiler 2 is configured so that the pressure gradient between the upper end 22, suitable to collect the infusion fluid in the gaseous state, and the lower end 20, suitable to collect the infusion fluid in the liquid state, is configured as a thrust suitable to cause the liquid infusion fluid to flow out through the drawing tube 3. In other words, the pressure gradient is suitable for pushing the infusion fluid in the liquid state out of the boiler 2, passing through the drawing tube 3.

The active configuration is preferably associated with the pre-infusion step, the infusion step and the step of dispensing the beverage and/or the step of feeding the service tap 6.

The drawing tube 3 is configured to convey the infusion fluid towards the inlet end 42. The infusion fluid is preferably taken at a boiler temperature of between 120 and 135° C.

In particular, the pressure in the boiler 2 is between 0 and 4 bar.

The inlet end 42 is configured as a first mixing point Pm′ suitable for mixing the infusion fluid flowed out from the drawing tube 3 with the infusion fluid circulating in the heating circuit 7 to obtain a first mixed infusion fluid at a first mixing temperature between 85 and 99° C.

According to the embodiment in FIG. 1, when the machine 1 is in the active configuration during the pre-infusion step, the dispensing unit 5 is configured to take the first mixed infusion fluid from the heating circuit 7 and to wet a substance to be infused without dispensing the beverage. In other words, the dispensing unit 5 is suitable for taking the first mixed infusion fluid originating from the heat exchanger 4 and circulating in the heating circuit 7, and is further suitable for wetting the substance to be infused, so as to perform the pre-infusion step.

Preferably, the machine 1 also comprises a filter carrier that engages with the dispensing unit 5 and that is suitable for housing the substance to be infused, for example ground or powdered coffee.

According to one embodiment, the machine 1 also comprises a service tap 6 that is suitable for dispensing the infusion fluid in the liquid state for the separate preparation of infusion beverages, for example tea, chamomile and herbal tea, and/or for replacing the infusion fluid contained in the boiler 2 and in the heating circuit 7.

Preferably, the service tap 6 dispenses at a tap temperature between 85 and 98° C.

Preferably, the service tap 6 cannot function during the steps of pre-infusion, infusion and dispensing of the beverage. The service tap 6 may alternatively function contemporaneously with the execution of the steps of pre-infusion, infusion and dispensing of the beverage. The step of feeding the service tap 6 may therefore be contemporaneous—or not contemporaneous—with the steps of pre-infusion, infusion and dispensing of the beverage.

Advantageously, the service tap allows to replace the infusion fluid contained in the boiler and in the heating circuit.

A further advantage associated with the presence of the service tap is that of allowing for the separate preparation of infusion beverages such as tea, chamomile of herbal tea. In particular, it is possible to immerse the bag of the substance to be infused in the hot water dispensable from the service tap, in order to obtain the desired beverage.

According to the embodiment in FIG. 3, when the machine 1 is in the active configuration during the step of feeding the service tap 6, the service tap 6 is configured to take, from the heating circuit 7, the first mixed infusion fluid coming from the heat exchanger 4. Therefore the service tap 6 is suitable for being fed with the first mixed infusion fluid.

In one embodiment, the service tap 6 takes from the heating circuit 7 upstream of the dispensing unit because otherwise, if it drew downstream, the dispensing from the service tap 6 would be at a tap temperature lower than 85° C. and therefore too cold.

According to one embodiment, the fluidic connection between the drawing tube 3 and the heat exchanger 4 is controlled by means of a first solenoid valve 8′. Such first solenoid valve 8′ is configured to control the flow of the infusion fluid between the drawing tube 3 and the heat exchanger 4 when the machine 1 is in the active configuration, for example during the pre-infusion step and/or during the step of feeding the service tap 6.

According to the embodiments represented in the accompanying FIGS. 4 and 5, the machine 1 also comprises a tank 9, a manifold 80 and a pump unit 90.

The tank 9 is suitable for containing the infusion fluid. In the example, the tank 9 is suitable for containing the infusion fluid at a tank temperature between 20 and 40° C.

The manifold 80 is fluidically connected to the tank 9. Preferably, the manifold 80 is a three way manifold.

The pump unit 90 is suitable for drawing the infusion fluid from the tank 9 to pump it to the manifold 80. Preferably, the pump unit 90 comprises a pump, for example a rotary or vibratory pump.

In particular, the manifold 80 comprises a first opening 81, a second opening 82 and a third opening 83.

The first opening 81 is fluidically connected to the tank 9 and suitable for receiving the infusion fluid pumped by the pump unit 90.

The second opening 82 is fluidically connected to the drawing tube 3 and suitable to convey the infusion fluid towards said drawing tube 3 to fill the boiler 2 (FIG. 5). In particular, the pumping of the infusion fluid to the drawing tube 3 occurs when the machine 1 is in the inactive configuration during the step of filling the boiler 2 or during the step of filling both the boiler 2 and the heating circuit 7.

Otherwise the second opening 82 is also suitable for receiving the infusion fluid from the drawing tube 3 (FIG. 4) when the machine 1 is in the active configuration, for example during the pre-infusion step and/or during the step of feeding the service tap 6. In other words, the second opening 82 is configured not only to convey the infusion fluid towards the boiler 2 but also to receive infusion fluid that has flowed out from the drawing tube 3.

The third opening 83 is fluidically connected to the heat exchanger 4 and is suitable to convey the infusion fluid towards said heat exchanger 4.

According to one embodiment, the first solenoid valve 8′ is positioned between the second opening 82 of the manifold 80 and the drawing tube 3.

Preferably, the machine 1 also comprises a second solenoid valve 8″ positioned between the pump unit 90 and the first opening 81 of the manifold 80.

According to one embodiment shown in FIG. 4, the boiler 2 is provided with a level sensor 25 configured to send an activation signal to the pump unit 90 if the level of the infusion fluid in the boiler 2 falls below a threshold value.

Preferably, the threshold value refers to the level of infusion fluid in the liquid state in the boiler 2. In the example, the threshold value is associated with a liquid level between 30% and 50% of the boiler 2 filling volume.

When the pump unit 90 is activated by the level sensor 25 and with the machine 1 in the active configuration, for example during the pre-infusion step and/or the step of feeding the service tap 6, the manifold 80 is configured to receive, at the first opening 81, the infusion fluid pumped by the pump unit 90, and to receive, at the second opening 82, the infusion fluid that has flowed out from the drawing tube 3 due to the pressure gradient in the boiler 2.

The manifold 80 is therefore also configured as a second mixing point Pm″ suitable to mix the infusion fluid of the boiler 2 with the infusion fluid of the tank 9, so as to form a second mixed infusion fluid.

Preferably, the infusion fluid originating from the boiler 2 is at a boiler temperature of 115-130° C., the one originating from the boiler 9 is at a tank temperature of 20-40° C., whilst the second mixed infusion fluid is at a second mixing temperature of 85-99° C.

Still more preferably, the infusion fluid from the boiler 2 is of between 120 and 125° C., whilst the second mixed infusion fluid is of between 90 and 95° C.

According to one embodiment, the boiler 2 is provided with a level sensor 25 configured to send an activation signal to the pump unit 90 if the level of the infusion fluid in the boiler 2 falls below the threshold value. When the pump unit 90 is activated by the level sensor 25, and with the machine 1 in the inactive configuration, the manifold 80 is configured to:
receive, at the first opening 81, the infusion fluid pumped by the pump unit 90; and
fill the boiler 2 only, or fill the boiler 2 and feed the heating circuit 7 (FIG. 5).

In particular, in the case wherein the manifold 80 only enables the filling of the boiler 2, the heating circuit 7 will subsequently be fed from the infusion fluid contained in the boiler 2.

Preferably, during the step of filling the boiler 2, the manifold 80 is suitable for allowing the flow of the infusion fluid through the second opening 82 and the drawing tube 3 to fill the boiler 2. On the other hand, during the step of filling the boiler 2 and the heating circuit 7, the manifold 80, other than filling the boiler 2, is also suitable for feeding the heating circuit 7 allowing the flow of the infusion fluid through the third opening 83 (FIG. 5).

In accordance with the embodiment according to the accompanying FIG. 4, the manifold 80 is suitable for allowing the second mixed infusion fluid to flow towards the heat exchanger 4, so that the inlet end 42 is suitable to allow the second mixed infusion fluid to be blended with the infusion fluid circulating in the heating circuit 7 to obtain a third mixed infusion fluid. In particular, the manifold is configured to control the flow of the infusion fluid through the third opening 83 so as to reach the inlet end 42 where, at the first mixing point Pm′, the second mixed infusion fluid blends with the infusion fluid circulating in the heating circuit 7 to obtain the third mixed infusion fluid.

The third mixed infusion fluid is preferably at a third mixing temperature of around 85-99° C.; still more preferably, it is at a third mixing temperature between 90 and 95° C.

According to one embodiment, with the machine 1 in the active configuration and during the pre-infusion step, the dispensing unit 5 is configured to take the third mixed infusion fluid from the heating circuit 7 in order to wet the substance to be infused without dispensing the beverage.

According to the embodiment shown in FIG. 4, with the machine 1 in the active configuration during the step of feeding the service tap 6, the service tap 6 is configured to take, from the heating circuit 7, the third mixed infusion fluid coming from the heat exchanger 4. The service tap 6 is thus suitable for being fed by the third mixed infusion fluid.

According to the present invention, it is furthermore proposed a method for pre-infusion and/or for feeding the service tap 6. Such method includes arranging the machine 1 for dispensing an infusion beverage.

The machine 1 comprises the service tap 6 and the infusion fluid contained in both the boiler 2 and the heating circuit 7. It should be noted that the heating circuit 7 is defined by the fluidic connection between the heat exchanger 4 and the dispensing unit 5. Such heating circuit 7 allows the infusion fluid to continuously recirculate between the heat exchanger 4 and the dispensing unit 5 and keeps the dispensing unit 5 at a temperature of 80-95° C.

The method furthermore involves applying a pressure to the infusion fluid in the liquid state, collected on the bottom wall 21 of the boiler 2 by the infusion fluid in the gaseous state collected close to the top wall 23. Such pressure causes the infusion fluid to flow out through the drawing tube 3.

The infusion fluid taken by the drawing tube 3 is conveyed towards the inlet end 42 of the heat exchanger 4. The infusion fluid coming from the boiler 2 is mixed with the infusion fluid circulating in the heating circuit 7, so as to obtain the first mixed infusion fluid at a first mixing temperature between 85 and 99° C.

Finally, the first mixed infusion fluid is introduced into the heating circuit 7, in so as to use said first mixed infusion fluid for wetting the substance to be infused and/or feeding the service tap 6.

According to one form of execution of the method, shown in the flow diagram of FIG. 7, in order to carry out the pre-infusion of the substance to be infused, the method also comprises a step of taking the first mixed infusion fluid from the heating circuit 7 at the dispensing unit 5 for wetting the substance to be infused without dispensing the beverage.

According to one execution form of the method shown in the flow diagram of FIG. 7, such method also comprises:
a further step of taking the first mixed infusion fluid from the heating circuit 7 to feed the service tap 6, and
a step of dispensing, through the service tap 6, the first mixed infusion fluid for separately preparing infusion beverages and/or replacing the infusion fluid contained in the boiler 2 and in the heating circuit 7.

According to one embodiment, the machine 1 also comprises the tank 9 containing the infusion fluid, the manifold 80 fluidically connected to the tank 9, the boiler 2 and the heat exchanger 4 and the pump unit 90. The boiler 2 is furthermore provided with the level sensor 25. The method also includes sending an activation signal to the pump unit 90 when the level sensor 25 detects that the level of the infusion fluid in the boiler 2 is below the threshold value. The infusion fluid contained in the tank 9 is pumped towards the manifold 80 by means of the pump unit 90. The infusion fluid of the tank 9 is mixed, at the manifold 80, with the infusion fluid of the boiler 2, so as to obtain a second mixed infusion fluid.

Finally, the second mixed infusion fluid is conveyed towards the heat exchanger 4.

In particular, the infusion fluid flows out from the drawing tube 3 due to the pressure gradient in the boiler 2 and is mixed with the infusion fluid pumped by the pump unit 90 to obtain the second mixed infusion fluid. The mixing occurs at the manifold 80, preferably at the second mixing point Pm″, where the infusion fluid arriving from the boiler 2 mixes with the infusion fluid arriving from the tank 9.

According to one form of execution of the method shown in the flow diagram of FIG. 8, such method also comprises a step of further mixing where, at the inlet end 42, the second mixed infusion fluid is blended with the infusion fluid circulating in the heating circuit 7 to obtain the third mixed infusion fluid. Such third mixed infusion fluid is then introduced into the heating circuit 7 to wet the substance to be infused and/or to feed the service tap 6.

According to one form of execution of the method shown in the flow diagram of FIG. 8, when the machine 1 is in the active configuration during the pre-infusion step, the dispensing unit 5 takes the third mixed infusion fluid from the heating circuit 7 and wets the substance to be infused without dispensing the beverage.

According to one form of execution of the method shown in the flow diagram of FIG. 8, the method also comprises a drawing step, wherein the service tap takes, from the heating circuit 7, the third mixed infusion fluid for separately preparing infusion beverages and/or replacing the infusion fluid contained in the boiler 2 and in the heating circuit 7. The step of feeding the service tap 6 preferably results in the dispensing of the third mixed infusion fluid from the service tap 6 and occurs when the machine 1 is in the active configuration.

Preferably, also proposed is a method for filling the boiler 2. In order to perform such method it is necessary to arrange the machine 1 which comprises the infusion fluid, the tank 9 wherein the infusion fluid is contained, the manifold 80 and the pump unit 90. In particular, the manifold 80, fluidically connected to the tank 9, to the boiler 2 and to the heat exchanger 4, comprises the first 81, the second 82 and the third opening 83. The boiler 2 is furthermore provided with the level sensor 25

The method comprises the following steps:
sending an activation signal to the pump unit 90 when the level sensor 25 detects that the level of the infusion fluid in the boiler 2 is below the threshold value;
pumping, by means of the pump unit 90, the infusion fluid contained in the tank 9 towards the manifold 80;
receiving, at the first opening 81 of the manifold 80, the infusion fluid pumped by the pump unit 90;
filling only the boiler 2, or filling the boiler 2 and also feeding the heating circuit 7 to keep the dispensing unit 5 at a temperature of 80-95° C.

Preferably and according to FIG. 6, an infusion beverage dispensing method is shown wherein the pump unit 90 sends the infusion fluid to the manifold 80; the manifold 80 diverts such infusion fluid to the heat exchanger 4 where it is introduced into the heating circuit 7. The infusion fluid is then taken by the heating circuit 7, at the dispensing unit 5, in order to infuse the substance and dispense the beverage. Only when the pump unit 90 is active is it possible to reach a pressure of 8-12 bar in order to dispense the beverage.

According to one aspect of the present invention, furthermore proposed is a control unit that is configured to implement the method for pre-infusion and/or for feeding the service tap 6.

Preferably, the control unit may be actuated by a user, for example by means of a touch screen interface or by means of a console comprising a plurality of buttons and/or levers and/or knobs. In particular, by means of the control unit, the user may control the starting and duration of the steps for the pre-infusion, infusion, beverage dispensing and feeding of the service tap.

The control unit preferably also comprises a microswitch that is configured to actuate the pump unit 90. It appears evident that by actuating the microswitch the pump unit is activated 90 and, with the release of the microswitch, the functioning of such pump unit 90 is halted. Nevertheless, during the filling of the boiler 2 the microswitch is off, this notwithstanding that the pump unit 90 is nonetheless activated by the level sensor 25 when the infusion fluid level in the boiler 2 is below the threshold value.

The infusion fluid, the first mixed infusion fluid, the second mixed infusion fluid and the third mixed infusion fluid are preferably of the same type of fluid, i.e. water; the designations “first,” “second,” and “third” are however intended to refer to different mixing stages.

Innovatively, the machine, the method and the control unit fulfill the intended object.

Advantageously, the drawing tube is sufficiently long to enable the drawing of the infusion fluid in the liquid state, i.e. at a significantly lower temperature than that of the infusion fluid in the gaseous state which is collected at the upper end of the boiler. In machines according to the state of the art, the drawing tube is instead short and contemporaneously takes both steam and liquid from the boiler. The machine according to the present invention therefore resolves the problem of splashing and steam emission during the steps of pre-infusion, infusion, dispensing of the beverage and of feeding the service tap.

According to one advantageous aspect the machine according to the present invention also allows to perform the pre-infusion step even with a single boiler and without connecting the machine to the water supply.

According to one still further advantageous aspect, the drawing tube, insofar as it has a length that is such for it to touch the back wall, allows the boiler to be filled from the bottom so as to avoid thermal shocks.

### Advantageously, During the Pre-infusion Step

and the step of feeding the service tap, the machine may avail itself of the infusion fluid contained in both the boiler and the tank. It is therefore possible to manufacture the boiler using dimensions that are more contained when compared to machines according to the state of the art.

In order to meet contingent needs, a person skilled in the art may make changes, adjustments and adaptations to the embodiments of the machine, the method and the control unit, according to the invention, and may replace elements with other functionally equivalent elements, without departing from the scope of the following claims. Each of the features described as belonging to a possible embodiment may be obtained independently of the other described embodiments.

1. A machine for dispensing an infusion beverage, the machine comprising:
a boiler suitable for heating an infusion fluid and extending between a lower end, delimited by a bottom wall, and an upper end, delimited by a top wall;
a drawing tube at least partially accommodated in the boiler and extending between a first end and a second end,
a heat exchanger extending between an inlet end, for an inflow of the infusion fluid, and an outlet end, for an outflow of the infusion fluid; and
a dispensing unit, suitable for dispensing the infusion beverage;
wherein the boiler is configured to obtain at the lower end, and in particular on the bottom wall, a significantly lower infusion fluid temperature than that obtainable at the upper end, in particular on the top wall,
the first end of the drawing tube being positioned close to the bottom wall of the boiler to draw the infusion fluid in a liquid state usable for a pre-infusion step or a step of feeding a service tap.

2. The machine of claim 1, the machine being convertible between an inactive configuration and an active configuration,
wherein, in the inactive configuration, the heat exchanger is fluidically connected to the dispensing unit so as to define a heating circuit suitable for allowing a continuous recirculation of the infusion fluid between the heat exchanger and the dispensing unit, so as to keep the dispensing unit at a temperature of 80-95° C. without dispensing the infusion beverage,
and wherein, in the active configuration, the boiler is configured so that a pressure gradient between the upper end, suitable to collect the infusion fluid in a gaseous state, and the lower end, suitable to collect the infusion fluid in the liquid state, is configured as a thrust suitable to cause the infusion fluid in the liquid state to flow out through the drawing tube,
the drawing tube being configured to convey the infusion fluid, optionally taken at a boiler temperature between 120° C. and 135° C., to the inlet end,
the inlet end being configured as a first mixing point suitable for mixing the infusion fluid flowed out from the drawing tube with the infusion fluid circulating in the heating circuit to obtain a first mixed infusion fluid at a first mixing temperature between 85° C. and 99° C.

3. The machine of claim 2, wherein, with the machine in the active configuration during the pre-infusion step, the dispensing unit is configured to:
take the first mixed infusion fluid from the heating circuit, and
wet a substance to be infused without dispensing the infusion beverage.

4. The machine of claim 2, further comprising a service tap suitable for dispensing the infusion fluid in the liquid state for separately preparing infusion beverages, optionally the infusion beverages being tea, chamomile tea and herbal teas, and/or changing the infusion fluid contained in the boiler and in the heating circuit.

5. The machine of claim 4, wherein, with the machine in the active configuration during the step of feeding the service tap, the service tap is configured to take, from the heating circuit, the first mixed infusion fluid coming from the heat exchanger, the service tap being suitable for being fed with the first mixed infusion fluid.

6. The machine of claim 2, wherein a fluidic connection between the drawing tube and the heat exchanger is adjusted by a first solenoid valve, the first solenoid valve configured to control a flow of the infusion fluid between the drawing tube and the heat exchanger when the machine is in the active configuration, optionally the active configuration being the pre-infusion step and/or the step of feeding the service tap.

7. The machine of claim 2, further comprising:
a tank suitable for containing the infusion fluid;
a manifold fluidically connected to the tank; and
a pump unit suitable for drawing the infusion fluid from the tank to pump the infusion fluid to the manifold,
wherein the manifold comprises:
i) a first opening fluidically connected to the tank and suitable for receiving the infusion fluid pumped by the pump unit;
ii) a second opening fluidically connected to the drawing tube and suitable to convey the infusion fluid towards the drawing tube to fill the boiler, or the second opening being suitable to receive the infusion fluid from the drawing tube when the machine is in the active configuration, optionally the active configuration being the pre-infusion step and/or the step of feeding the service tap; and
iii) a third opening fluidically connected to the heat exchanger and suitable to convey the infusion fluid towards said the heat exchanger.

8. The machine of claim 7, wherein a fluidic connection between the drawing tube and the heat exchanger is adjusted by a first solenoid valve, the first solenoid valve being configured to control a flow of the infusion fluid between the drawing tube and the heat exchanger when the machine is in the active configuration, optionally the active configuration being the pre-infusion step and/or the step of feeding the service tap, wherein the first solenoid valve is positioned between the second opening of the manifold and the drawing tube, and wherein the machine further comprises a second solenoid valve positioned between the pump unit and the first opening of the manifold.

9. The machine of claim 7, wherein the boiler is provided with a level sensor configured to send an activation signal to the pump unit if a level of the infusion fluid in the boiler falls below a threshold value, and wherein
when the pump unit is activated by the level sensor and with the machine in the active configuration, optionally the active configuration being the pre-infusion step and/or the step of feeding the service tap, the manifold is configured to receive, at the first opening, the infusion fluid pumped by the pump unit, and to receive, at the second opening, the infusion fluid flowed out from the drawing tube due to the pressure gradient in the boiler,
the manifold being also configured as a second mixing point suitable to mix the infusion fluid coming from the boiler with the infusion fluid coming from the tank, so as to form a second mixed infusion fluid.

10. The machine according of claim 7, wherein the boiler is provided with a level sensor configured to send an activation signal to the pump unit if a level of the infusion fluid in the boiler falls below a threshold value, and wherein
when the pump unit is activated by the level sensor, and with the machine in the inactive configuration, the manifold is configured to:
i) receive, at the first opening, the infusion fluid pumped by the pump unit; and
ii) fill the boiler only, or fill the boiler and feed the heating circuit.

11. The machine of claim 9, wherein the manifold is suitable to allow the second mixed infusion fluid to flow towards the heat exchanger, so that the inlet end is suitable to allow the second mixed infusion fluid to be blended with the infusion fluid circulating in the heating circuit to obtain a third mixed infusion fluid.

12. The machine of claim 11, further comprising a service tap suitable for dispensing the infusion fluid in the liquid state for separately preparing infusion beverages, optionally the infusion beverages being tea, chamomile tea and herbal teas, and/or changing the infusion fluid contained in the boiler and in the heating circuit, wherein, with the machine in the active configuration during the step of feeding the service tap, the service tap is configured to take, from the heating circuit, the third mixed infusion fluid coming from the heat exchanger, the service tap being suitable for being fed with the third mixed infusion fluid.

13. A method for pre-infusion and/or for feeding a service tap, the method comprising the following steps:
providing a machine for dispensing an infusion beverage, the machine comprising:
a boiler suitable for heating an infusion fluid and extending between a lower end, delimited by a bottom wall, and an upper end, delimited by a top wall;
a drawing tube at least partially accommodated in the boiler and extending between a first end and a second end,
a heat exchanger extending between an inlet end, for an inflow of the infusion fluid, and an outlet end, for an outflow of the infusion fluid; and
a dispensing unit suitable for dispensing the infusion beverage;
wherein the boiler is configured to obtain at the lower end, and in particular on the bottom wall, a significantly lower infusion fluid temperature than that obtainable at the upper end, in particular on the top wall.
the first end of the drawing tube being positioned close to the bottom wall of the boiler to draw the infusion fluid in a liquid state usable for a pre-infusion step or a step of feeding a service tap, the machine further comprising
i) an infusion fluid contained in both the boiler and a heating circuit defined by a fluidic connection between the heat exchanger and the dispensing unit, the heating circuit allowing the infusion fluid to continuously recirculate between the heat exchanger and the dispensing unit, so as to keep the dispensing unit at a temperature of 80-95° C.; and
ii) a service tap;
applying a pressure to the infusion fluid in the liquid state collected on the bottom wall of the boiler by the infusion fluid in a gaseous state collected close to the top wall, the pressure causing the infusion fluid in the liquid state to flow out through the drawing tube;
conveying the infusion fluid taken by the drawing tube to the inlet end of the heat exchanger;
mixing the infusion fluid coming from the boiler with the infusion fluid circulating in the heating circuit, so as to obtain a first mixed infusion fluid at a first mixing temperature between 85° C.; and 99° C.; and
introducing the first mixed infusion fluid into the heating circuit, so as to use the first mixed infusion fluid for wetting a substance to be infused and/or feeding the service tap.

14. The method of claim 13, wherein, to carry out a pre-infusion of the substance to be infused, the method further comprises a step of taking the first mixed infusion fluid from the heating circuit at the dispensing unit for wetting the substance to be infused without dispensing the infusion beverage.

15. The method of claim 13, further comprising:
a further step of taking the first mixed infusion fluid from the heating circuit to feed the service tap, and
a step of dispensing, through the service tap (6), the first mixed infusion fluid for separately preparing infusion beverages and/or replacing the infusion fluid contained in the boiler and in the heating circuit.

16. The method of claim 13, wherein the machine further comprises:
a tank containing the infusion fluid;
a manifold fluidically connected to the tank, the boiler, and the heat exchanger; and
a pump unit,
the boiler being further provided with a level sensor,
the method further comprising the following steps:
sending an activation signal to the pump unit when the level sensor detects that a level of the infusion fluid in the boiler is below a threshold value;
pumping, by the pump unit, the infusion fluid contained in the tank towards the manifold;
mixing, at the manifold, the infusion fluid coming from the tank with the infusion fluid coming from the boiler, so as to obtain a second mixed infusion fluid; and
conveying the second mixed infusion fluid towards the heat exchanger.

17. The method of claim 16, further comprising a further mixing step, where, at the inlet end, the second mixed infusion fluid is blended with the infusion fluid circulating in the heating circuit, so as to obtain a third mixed infusion fluid, the third mixed infusion fluid being then introduced into the heating circuit for wetting the substance to be infused and/or feeding the service tap.

18. The method of claim 17, further comprising a taking step in which the service tap takes, from the heating circuit, the third mixed infusion fluid for separately preparing infusion beverages and/or replacing the infusion fluid contained in the boiler and in the heating circuit.

19. A control unit configured to implement the method of claim 13.
